(19) United States
(12) Patent Application Publication
(10) Pub. No.: US 2011/0051547 A1
(43) Pub. Date: Mar. 3, 2011

(54) ARRANGEMENT AND METHOD AT A MILKING STATION FOR ACHIEVING A REPRESENTATIVE MILK SAMPLE

(75) Inventors: Mats Gudmundsson, Sodertalje (SE); Juoko Raninen, Marsta (SE); Nils Erik Holmertz, Huddinge (SE); Carina Fjallmyr, Grodinge (SE); Staffan Persson, Tumba (SE); Epke Bosma, Holo (SE)

(73) Assignee: DELAVAL HOLDING AB, Tumba (SE)

(21) Appl. No.: 12/865,514

(22) PCT Filed: Jan. 27, 2009
(86) PCT No.: PCT/SE2009/050081

§ 371 Date: Nov. 17, 2010

(30) Foreign Application Priority Data
Jan. 30, 2008 (SE) 0800228-9

(51) Int. Cl. A01J 5/007; B01F 15/00

(52) U.S. Cl. 366/140; 119/14.18

(57) ABSTRACT

A method and arrangement for providing a representative milk sample from one animal, includes milk extracting parts, a receiver, a milk transferring part to transfer the milk from the receiver to a sampling unit, milk stirring parts adapted to stir the milk before transferring a sample part of the milk to the sample unit, a milk yield determining part, a stirring time determining part, the arrangement adapted to terminate the stirring of the milk when the time period ends so that a satisfactorily stirring can be accomplished without subjecting the milk to excessive stirring.

### TECHNICAL FIELD

The present invention relates to milking stations and methods of providing samples of milk, and in particular it concerns providing milk samples being representative for analyzing the constituents, e.g. fat, of the milk.

### BACKGROUND AND PRIOR ART

Milk is a sensitive food product that requires gentle treatment. At the same time it is important to subject the milk for testing, such as an automatic somatic cell counting unit (OCC) to discover infections, and analysing the contents of its constituents, especially establishing how rich the milk is in fat content. Moreover, the fat concentration varies during a milking process and when the milk is received in a container its fat is generally not homogeneously distributed in the container. If a sample of milk is analysed, it is important that the sample is representative of the whole milk quantity. One way to provide a representative sample is to take samples continuously during a milking process, which samples are then collected in a sample container where it is subjected to pressurised air, bubbling the milk, to spread the fat evenly.

EP, 564023, A1 describes another method to reduce the risk of providing less representative samples, where all milk extracted from an animal is drawn to a milk meter, where it is subjected to pressurised air, bubbling the milk, so the milk is stirred before a sample is taken. An aim is to stir the milk so every fraction of it is representative for the whole quantity. However, besides distributing the fat, such air bubbling process contributes to the emergence of free fatty acids (FFA) in the milk. The free fatty acids lessen the quality of the milk and can cause an undesired taste.

### SUMMARY OF THE INVENTION

The invention relates to milking equipment, especially automatic equipment provided with means for sampling the milk. The method according to the invention, and the arrangement performing the method, can be implemented in a milking robot to provide a sample of the milk that is extracted during a milking process, which sample is representative regarding its constituents to the extracted total amount of milk. Besides providing representative milk samples, an object of the invention is to overcome the disadvantages of the prior art and avoid raising the levels of free fatty acids in the milk.

For this purpose the invention provides an arrangement for providing a representative sample of milk from one animal, e.g. a cow, in a milking station comprising means for extracting milk from the animal, a receiver, and means for transferring the milk from the receiver, wherein the extracting means is adapted to extract milk from the animal to the receiver, and the transferring means comprises an outlet arranged for transferring a sample part of the milk from the receiver to a sampling unit. The arrangement further comprises

means for stirring the milk, the stirring means being adapted to stir the milk before transferring a sample part of the milk to the sample unit, and the arrangement is characterised in that it comprises means for determining a milk yield of the animal in the receiver, means for determining a stirring time period on the basis of the milk yield, and the arrangement is adapted to terminate the stirring of the milk when the time period has lapsed, so the stirring is limited by the time period. By stopping the stirring when the time period ends a satisfactorily stirring, for providing a milk sample being representative for the milk quality and its constituents, especially in fat content, can be accomplished without subjecting the milk to excessive stirring.

The invention also provides a method of sampling milk in a milking station wherein milk is extracted from an animal and transferred to a receiver, adapted for receiving the milk amount from one animal at one milking operation, the amount of extracted milk is determined, a main part of the milk is transferred from the receiver to a storage tank adapted for receiving milk from several animals and a sample part of the milk is transferred from the receiver to a milk sampling unit for sampling milk for a subsequent analysis of its fat content. The method comprises the step of stirring the milk before a part of the milk is transferred from the receiver to the milk-sampling unit, thereby ensuring that the sampled part is representative of the milk from one animal, at least in regard of fat content. By stirring substantially all the extracted milk, all of the milk becomes representative and a small fraction can be sampled having the same constitution as the whole milk quantity. The method according to the invention is characterised in that an optimum stirring time is determined based on the milk yield of the animal, e.g. extracted amount, and the stirring process is terminated when the stirring period has lapsed. This optimum is an interval, long enough to distribute the constituents of the milk, but limited so as not to unnecessarily raise the levels of free fatty acids in the milk. By adjusting the stirring time period based on the volume an appropriate mixing of the milk is performed, still handling the milk in a gentle way.

In one embodiment the arrangement comprises means for determining the amount of extracted milk and using the amount of extracted milk as the milk yield.

An alternative to use a measured amount of milk to limit the stirring is to determine the amount based on individual historical data for the animal. One embodiment comprise a database for storing milking data for individual animals and the arrangement is adapted to use stored milking data for the animal to determine the milk yield of the animal. Preferably, the used milking data comprise measured milk amounts from previous milking sessions and time data indicating the last time the animal was milked.

The arrangement can be provided with an identification unit that automatically identifies the animal, and use the automatically produced identity data to provide the individual milking data for the animal from the database.

By determining the stirring time based on the individual animal or the amount of extracted milk during the milking session in question, the stirring time can be limited further than if, for example, a standard stirring time or default value where used, since such default values risks stirring small quantities of milk for too long and unnecessarily contribute to the creation of free fatty acids in the milk.

An embodiment provides a method, wherein the stirring is performed by circulating the milk, in a loop, preferably by pumping the milk from the receiver and back to the receiver.

In an embodiment of the arrangement, the pump is adapted to pump milk from the receiver and comprises a main outlet arranged for transferring a main part of the milk from the receiver to a storing tank for receiving milk from several animals and a means for transferring a sample part of the milk from the receiver to a sampling unit. It is adapted to stir the milk before transferring a sample part of the milk to the sample unit, and preferably a stirring time period is determined on the basis of the measured extracted amount.

An embodiment provides an arrangement, wherein the stirring means includes a return line conveying milk pumped from the receiver back into the receiver. Preferably, the return line is arranged to direct the milk flowing into the receiver in a direction at an angle downwards.

Alternative, or additionally, the return conduit comprises a plurality of nozzles entering into the receiver, which nozzles, preferably are selectable by means of a control unit, so that a proper entering height of the circulating milk can be chosen.

The nozzle can be arranged, or chosen among several nozzles, to inject milk close to the surface, preferably below the surface, to prevent air from being drawn into the milk.

In other embodiments the stirring means are arranged inside the receiver and/or comprises rotatable blades, or a reciprocating vane or an Archimedean screw-pump.

The use of other stirring means and methods than bubbling the milk with pressurised air have the advantage that air is not mixed into the milk, and therefore avoid production of free fatty acids even further.

The invention also provides a milking station comprising any of the arrangements described above.

### BRIEF DESCRIPTION OF THE DRAWINGS

The invention is described below, by way of example, with reference to the accompanying drawings, in which:

FIG. 1 illustrates a first arrangement of a milking station comprising a stirring loop.

FIG. 2 illustrates a second arrangement of a milking station comprising mechanical stirring means arranged inside a milk receiver in the milking station.

FIG. 3 illustrates an embodiment of a milking station comprising a stirring loop, which loop selectively leads the milk into the receiver through a plurality of nozzles.

It should be noted that the figures illustrate the main parts of the arrangements in accordance with the invention schematically, in side views, the parts are illustrated transparent where appropriate and they are not drawn to scale.

### DETAILED DESCRIPTION OF EMBODIMENTS

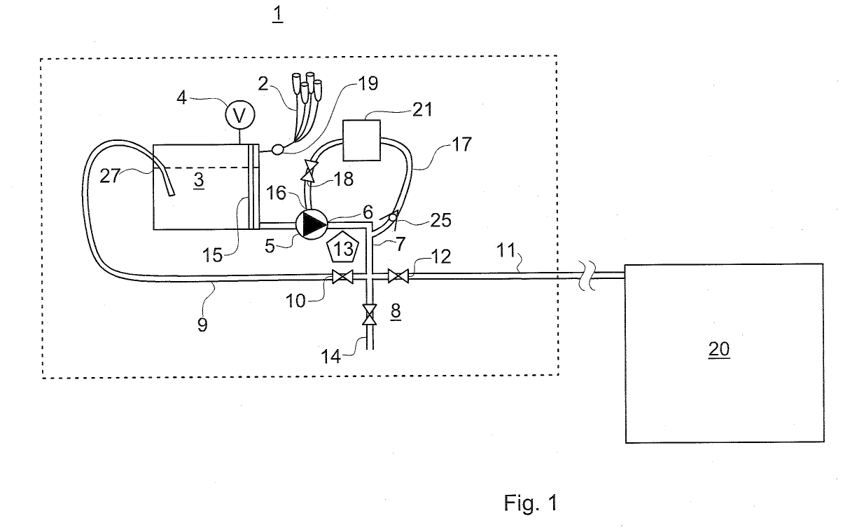

FIG. 1 illustrates schematically parts of an automatic milking station 1 or milking robot for milking animals, such as cows. The milking station comprises teat cups and hoses 2 connected to a milk receiver 3 that is connected to a vacuum source 4 so that the receiver can be put under vacuum to draw milk from the animal to the receiver. The receiver 3 is connected to a milk storage tank 20, to transfer milk from the milking station 1 to the storage tank after milking an animal. For this purpose a milk pump 5 is arranged at the receiver, at its outlet, which pump 5 is a centrifugal pump and is connected to the storage tank 20 via a valve arrangement 8, including a tank valve 12 that is arranged for selectively connecting a main outlet 6 of the pump 5 to the tank conduit line 11. The valve arrangement 8 also includes a drain valve 14 for connecting the receiver 3, and transferring milk of inferior quality, to a drain. At the beginning of a milking process the teat cups 2 are connected to the animal to be milked, after which milk is extracted and drawn to the receiver. The size of the receiver is suitably adapted to contain the amount of milk being extracted during a single milking process of an animal. At the end of the milking process the milk is transferred from the receiver 3, by the pump 5, to the storage tank 20 via tank conduit 11. The storage tank is much larger than the receiver and adapted to contain milk extracted from several milking processes of several animals. It also includes cooling means, for cooling the milk. Before, or when, the milk is pumped to the storage tank it can be sampled for analysis. For this purpose, a minor outlet 16 of the pump 5 is connected to a sample unit 21, via a selectively activated sample valve 18 and a sample pipe or conduit 17.

The milking station also comprises means for stirring the milk before it is transferred to the sample unit 21. These stirring means comprises a return conduit 9, selectively connectable by means of a stirring valve 10 connected to the pump 5 outlet 6, so that pumped milk can be conveyed back to the receiver 3. In this way the milk is pumped by the pump 5 in a loop through the return conduit 9 where it stirs the milk in the receiver so that the milk attains a more homogenous composition, especially the fat is more evenly distributed, before transferring the milk to the sample unit 21. The milking station includes a controller or control unit, 13 adapted to control the milking process, the stirring process and the transferring process. The control unit 13 controls the stirring of milk, which has been extracted from an animal, in the receiver. The stirring process can be initiated before the milking process is finished so that a part of the milk is being stirred before all the milk has been extracted. The control unit can also interrupt the stirring and resume stirring providing an intermittent stirring process. It is important to provide a thorough stirring of the milk, still creating a minimum level of free fatty acids in the milk during this process. The total stirring time is much shorter than the milking process. The milking station includes means for determining the amount of milk that is extracted when milking an animal, such as, a flow sensor 19 arranged at the hose 2 measuring the flow from the teat cups 2 to the receiver 3 and/or a level detector or level sensor 15 in the receiver arranged to detect the milk level in the receiver. Alternative arrangements include a separate receiver connected to each teat cup receiving milk from one teat each, e.g. so that milk from each teat can be analysed separately. Irrespective of one or four receiving units, there can be one flow sensor arranged in each hose receiving milk from each teat cup and/or a level sensor in each receiving unit. When the amount of milk has been determined the time for the stirring operation can be determined by the control unit 13 based on this volume. Since the stirring process is performed for mixing and blending the milk to a more homogenous composition with the fat evenly spread, it involves a less gentle treatment that can affect the milk negatively by creating free fatty acids (FFA). To prevent the creation of FFA the stirring is limited to a minimum for every given volume of milk. Thus, the control unit uses the determined volume indication to define a stirring time period, and interrupts the stirring when this time period ends.

FIG. 1 illustrates an embodiment for performing the stirring process wherein the milk from an animal is conveyed out of the receiver and pumped back into the receiver through an inlet of the stirring loop. This inlet directs the milk downward toward the bottom of the receiver in a direction below the horizontal plane between 30 and 60 degrees, or approximately 45 degrees. The inlet can be provided for by a nozzle protruding into the receiver arranged at a height suitable for injecting the milk, preferably below the milk surface (27) and towards the bottom of the receiver.

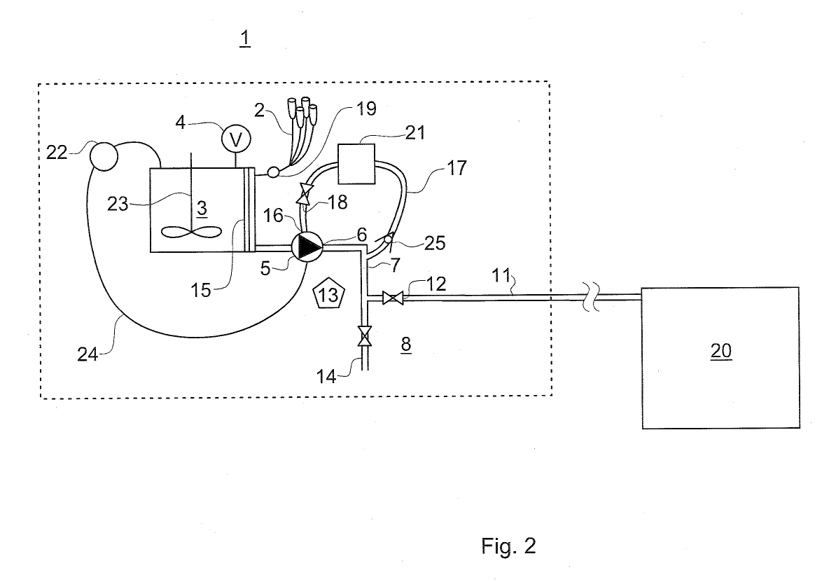

FIG. 2 illustrates an alternative system, where stirring means are incorporated inside the receiver. The extraction and the transferring processes and the means for these processes are the same as those illustrated in FIG. 1. In FIG. 2 the whole stirring process is performed in the receiver without the milk leaving the receiver, in contrast to the system of FIG. 1 where the milk is stirred in the receiver but the stirring is performed by milk, which has left the receiver and has been outside the receiver, that enters the receiver again. The milking station (in FIG. 2) comprises a receiver 3 provided with blades 23, rotateably arranged to stir the milk by rotation. An alternative to rotating blades is vanes (not illustrated) arranged for being driven in a reciprocating motion. Yet another embodiment includes a screw or screw-pump of Archimedean type for performing the stirring process.

The level sensor 15 is also used to stop the transferring process when the receiver is empty, or substantially empty.

After the stirring, the milk is transferred by the pump 5 (in FIG. 1 and FIG. 2) in a main flow to the storage tank 20 and a minor flow through the sample unit 21 where a sample can be extracted, for example, in a sample bottle for further analysis of the fat content.

Depending on the actual conduits, reservoirs and pumps used the time needed to stir the milk varies. When dimensioning the arrangement a succession of tests can suitably be performed where the milk is stirred until it is sufficiently mixed. The milk can, for example, be sampled at regular time intervals during the stirring process to determine how long stirring time is needed for any given quantity of milk.

In a further embodiment the pump 5 of the arrangement in FIG. 1 can be a variable speed pump, which is arranged to provide a higher speed when stirring the milk and a lower speed during transfer of milk to the storage tank 20 and the sample unit 21.

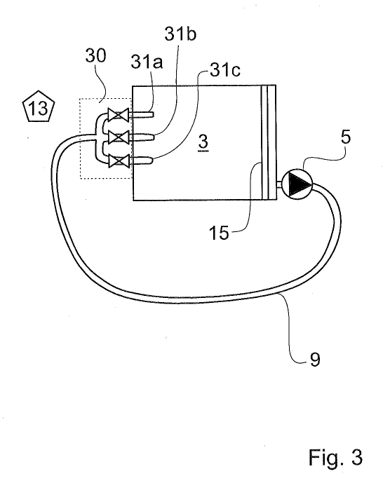

FIG. 3 illustrates an embodiment where the milk is lead back into the receiver at different heights. In this embodiment, the circulation line 9 comprises a plurality of nozzles 31a-c entering into the receiver 3. The control unit 13 is preferably able to selectively 30 lead the milk through the nozzles 31a-c, by means of a valve arrangement 30 adapted to lead milk from the circulation conduit 9 into the receiver through one of the nozzles 31a-c that enters into the receiver at different heights. The control unit 13 is adapted to choose the entering height, by choosing inlet 31a-c, on the basis of the amount of milk, for example determined by a level detector 15. A nozzle can be chosen that is positioned at a height suitable for injecting the circulated milk below the surface of the milk in the receiver, so that air is prevented from mixing into the milk. This embodiment can be also used in combination to the embodiment having a pump 5 with variable speed. These nozzles 31a-c enter the receiver in a horizontal direction, but can be arranged to lead the milk in a direction downwards, as described in above regarding FIG. 2.

The system of FIG. 2 also includes a separate line 24 or cell counting conduit, from the pump 5 back to the receiver 3, passing milk to an SCC unit 22, such as an automatic online cell counter (OCC), to detect infections. This cell counter loop (24) can also be incorporated in the arrangement in FIG. 1, but where omitted for clarity reasons only. The system is suitably arranged to transfer milk in this minor flow loop (24) for every milking process, to detect if the extracted milk is unfit for consumption.

The more powerful stirring process, in accordance with the invention, for dispersing the constituents of the milk, especially the fat, can suitably be activated only for selected milking occasions. For this purpose the control unit 13 of the system can be provided with a user interface adapted for activating the stirring process to provide milk samples for fat content analysis on demand rather than as a default test. The milking station 1 preferably comprises an animal identification unit (not shown) that identifies the animal when it is to be milked and the control unit 13 registers the results from the operations, such as milk amount, in a database. The data in the database can then be used to determine the expected milk yield from an individual animal, using for example the amounts from the latest milking sessions and the time interval since the preceding milking session.

In this way the on demand sampling process for fat analysis can suitably be automated so that the control unit upon identifying the animal checks in the database if the milk shall be subjected to fat analysis and, if so, activates the stirring process and sampling process for this specific animal.

In this way the stirring process is only performed when the fat content of the milk is to be established. Thus, if stirring has not been performed, the milk is transferred by the pump in a main flow to the storage tank 20 but there is no milk transferred in the minor flow through the sample unit 21.

1-15. (canceled)

16. An arrangement for providing a representative sample of milk from one animal in a milking station, the arrangement comprising:
milk extracting parts arranged for extracting milk from the animal;
a receiver connected to the milk extracting parts to receive the extracted milk from the milk extracting parts;
a milk transferring unit connected to the receiver to transfer the milk from the receiver;
a sampling unit connected to a first outlet of the milk transferring unit;
a milk stirring arrangement, the milk stirring arrangement arranged to stir the milk before transferring a sample part of the milk to the sampling unit;
a milk yield determining unit arranged to determine a milk yield of the animal from which the milk is extracted;
a milk stirring time period determining unit arranged to determine a stirring time period on the basis of the determined milk yield; and
a control unit adapted to limit the stirring of the milk to the determined milk stirring time period.

17. The arrangement according to claim 16, further comprising:
a milk extraction determining unit arranged to determine the amount of extracted milk,
wherein the determined amount of extracted milk is used for the milk yield determining unit determining the milk yield.

18. The arrangement according to claim 16, further comprising:
a database storing milking data for individual animals,
wherein the milk yield determining unit is adapted to use stored milking data for the animal to determine the milk yield of the animal.

19. The arrangement according to claim 18, wherein the used milking data comprises measured milk amounts from previous milking sessions and time data indicating the last time the animal was milked.

20. The arrangement according to claim 18, further comprising:
an identification unit adapted to automatically identify the animal,
wherein the milk yield determining unit is adapted to use the identity to provide the individual milking data for the animal.

21. The arrangement according to claim 16, further comprising:
a return line connected to receive milk from the receiver and return the received milk back to the receiver; and
stirring elements arranged with the return line arranged to stir the milk when conveying the milk from the receiver and back to the receiver.

22. The arrangement according to claim 16, further comprising a stirring element comprised of a mechanical agitator arranged inside the receiver.

23. The arrangement according to claim 16, further comprising;
a storage tank;
a milk line connecting a second outlet of the milk transferring unit to the storage tank, the milk line being arranged for transferring a main part of the milk from the receiver to the storage tank.

24. A method of providing a representative sample of milk from one animal in an automated milking station, comprising:
extracting milk from the animal;
receiving the extracted milk from the milking session in a milk receiver;
determining the amount of milk extracted from the animal, the determination expressed as a milk yield;
stirring the milk in the receiver for a time period, the time period being limited based on the determined milk yield of the animal;
after the stirring step is complete, transferring the milk from the milk receiver, the transferring step including transferring a sample part of the milk from the receiver to a sample unit.

25. The method according to claim 24, wherein the stirring step is performed intermittently in a plurality of time intervals.

26. The method according to claim 24, comprising the further step of determining the amount of extracted milk and using the determined amount of extracted milk as the milk yield.

27. The method according to claim 24, comprising the further step of using individual historical data of the animal for determining the milk yield.

28. The method according to claim 24, wherein the stirring step is performed inside the receiver.

29. The method according to claim 28, wherein the stirring step is performed by agitating the milk with a mechanical agitator.

30. The method according to claim 24, wherein the stirring step is performed by circulating the milk in a loop extending from the receiver and back to the receiver.

31. An arrangement for providing a representative sample of milk from one animal milked in a milking station, the arrangement comprising:
a receiver connected to receive extracted milk from the animal;
a milk transfer unit connected to the receiver;
a sampling unit connected to an outlet of the milk transfer unit;
a milk stirring arrangement, the milk stirring arrangement arranged to stir the milk in the receiver before transferring a sample part of the milk from the receiver, via the milk transfer unit, to the sampling unit; and
a control unit configured to limit the stirring of the milk to the determined milk stirring time period, the determined milk stirring time period based on a milk yield of the animal from which the milk is extracted.
